(19) United States
(12) Patent Application Publication
(10) Pub. No.: US 2019/0050590 A1
(43) Pub. Date: Feb. 14, 2019

(54) Ensuring Information Security by Utilizing Encryption of Data

(71) Applicant: Bank of America Corporation, Charlotte, NC (US)

(72) Inventors: James Alexander, Dripping Springs, TX (US); Srikanth Balagangadhar, Hockessin, DE (US); Andrea J. Coleman, Sachse, TX (US)

(21) Appl. No.: 15/675,974

(22) Filed: Aug. 14, 2017

(51) Int. Cl. G06F 21/62; H04L 29/06; G06F 21/72; H04L 9/08

(52) U.S. Cl. CPC G06F 21/6218; H04L 63/0428; H04L 9/0816; H04L 63/061; G06F 21/72

(57) ABSTRACT

Systems for ensuring data security when processing events through various channels are provided. The system may receive a request to process an event. An event processing device identifier may be extracted from the event processing device and encrypted using a first encryption process. The system may receive user identifying information, such as a personal identification number (PIN). The user identifying information may be encrypted with the encrypted event processing device identifier in a second encryption process. The encrypted data may be transmitted for authentication of the user and/or authorization to process the event. A second decryption process may be used to decrypt the encrypted user identifying information and encrypted event processing device identifier. A first encryption process may be used to decrypt the encrypted event processing device. The decrypted information may be used to authenticate the user and/or process the event.

### BACKGROUND

Aspects of the disclosure relate to electrical computers, systems, and encryption processes. In particular, one or more aspects of the disclosure relate to ensuring data security by utilizing encryption of data in processing events.

Event processing often requires multiple steps and the use of multiple devices, or inputs received via multiple devices, to authenticate a user and/or authorize processing. In some conventional arrangements, systems available for authenticating a user and/or authorizing processing might not provide sufficient data security for the information being used to process events. Further, in some examples, certain channels might not be used to process events because of concerns over data security. Accordingly, it would be advantageous to provide a secure system that uses encryption to ensure data security while simplifying the inputs and devices used to process events.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with ensuring data security when processing events through various channels.

In some examples, a system, computing platform, or the like, may receive a request to initiate or process an event. The request may include interaction between the system, computing platform, or the like, and an event processing device (e.g., via a computing device, such as a mobile computing device). In some arrangements, an event processing device identifier may be extracted from the event processing device and encrypted using a first encryption process.

In some examples, the system, computing platform, or the like, may receive user identifying information. In some examples, the user identifying information may be a personal identification number (PIN) input to the mobile computing device. The user identifying information may be encrypted with the encrypted event processing device identifier in a second encryption process.

In some arrangements, the encrypted data may be transmitted for authentication of the user and/or authorization to process the event. A second decryption process may be used to decrypt the encrypted user identifying information and encrypted event processing device identifier. A first encryption process may be used to decrypt the encrypted event processing device.

In some examples, the decrypted user identifying information may be used to authenticate the user requesting processing of the event. If the user is authenticated, the processing may be authorized and the event may be processed. If the user is not authenticated, the process may be prevented.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A, 1B and 1C depict an illustrative computing environment for implementing information security control functions in accordance with one or more aspects described herein;

FIGS. 2A-2D depict an illustrative event sequence for implementing information security control functions in accordance with one or more aspects described herein;

FIG. 3 depicts an illustrative method for implementing and using a system to perform information security control functions, in accordance with one or more aspects described herein;

FIG. 4 depicts another illustrative method for implementing and using a system to perform information security control functions, in accordance with one or more aspects described herein;

FIG. 5 illustrates one example user interface that may be generated in response to one or more information security control functions, in accordance with one or more aspects described herein;

FIG. 6 illustrates another example user interface that may be generated in response to one or more information security control functions, in accordance with one or more aspects described herein;

FIG. 7 illustrates one example operating environment in which various aspects of the disclosure may be implemented in accordance with one or more aspects described herein; and

FIG. 8 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using encryption to provide information security control functions when processing one or more events.

In many instances, processing events may involve using multiple devices, systems, or the like, to obtain information, authenticate a user, process the event, and the like. Ensuring the security of the data being used to process the events is of utmost importance.

Accordingly, aspects described herein provide for ensuring information security during event processing. The aspects described herein relate to systems, computing platforms, and the like, for receiving requests to process an event and extracting data associated with an event processing device. In some examples, the extracted data may be encrypted using a first encryption process.

In some arrangements, user identifying information may be received. The user identifying information may include a personal identification number (PIN) of the user. This user identifying information may be encrypted with the encrypted extracted data and may be used to authenticate a user and/or authorize processing the transaction.

In some examples, a second decryption process may be used to decrypt the user identifying information. A first decryption process may then be used to decrypt the encrypted extracted data. This information may be used to authenticate a user requesting processing of the event and/or to authorize processing of the event.

These and various other arrangements will be discussed more fully below.

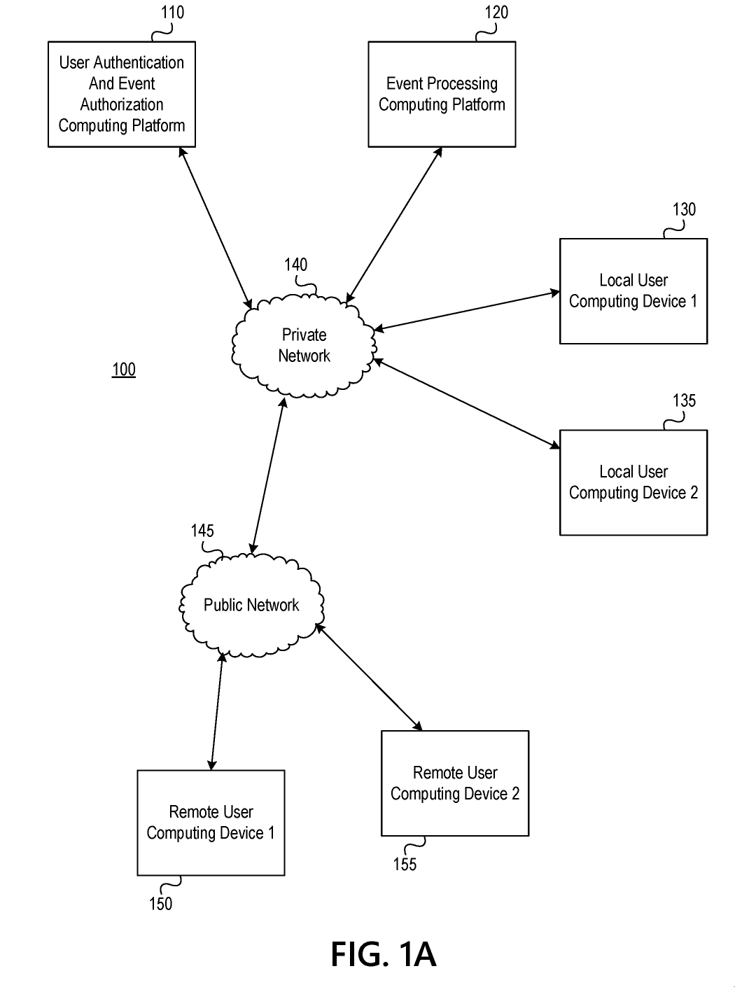

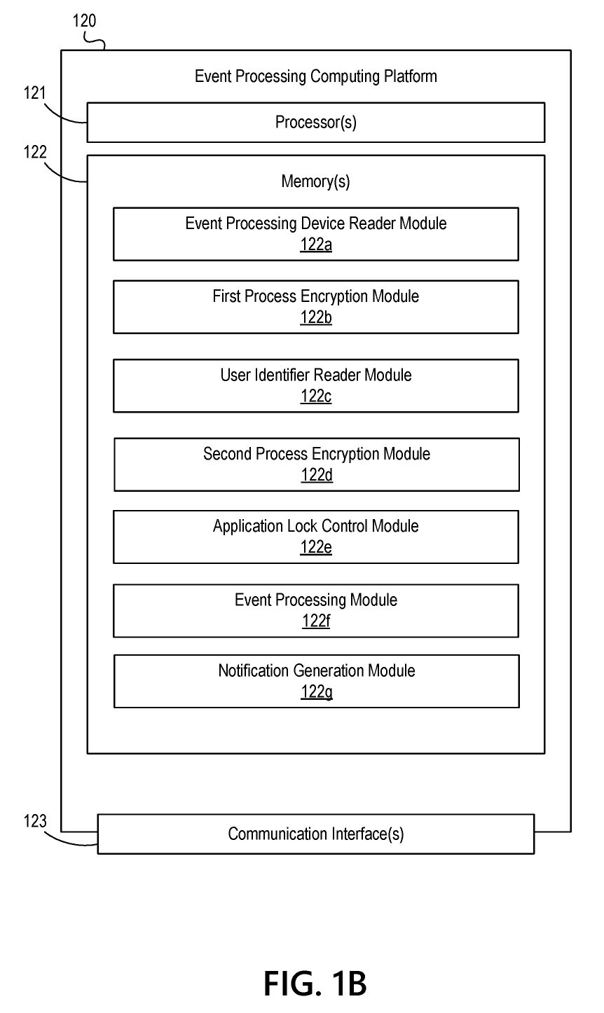

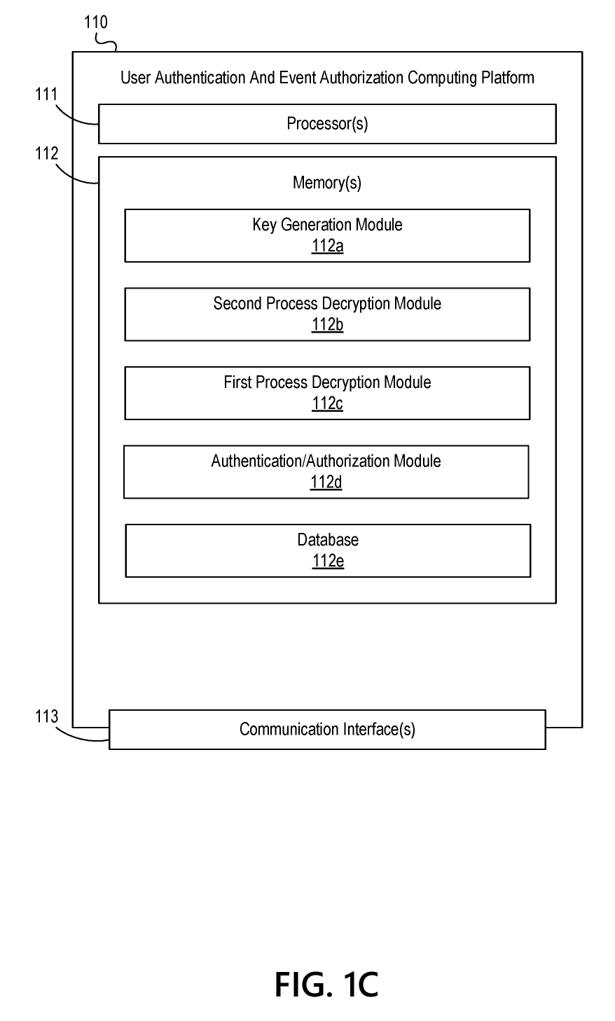

FIGS. 1A-1C depict an illustrative computing environment for implementing and using a user authentication and event processing system in accordance with one or more aspects described herein. Referring to FIG. 1A, computing environment 100 may include one or more computing devices and/or other computing systems. For example, computing environment 100 may include a user authentication and event authorization computing platform 110, an event processing computing platform 120, a first local user computing device 130, a second local user computing device 135, a first remote user computing device 150, and a second remote user computing device 155.

User authentication and event authorization computing platform 110 may be configured to host and/or execute one or more modules including instructions for providing various user authentication and event authorization functions. In some examples, user authentication and event authorization computing platform 110 may be configured to generate a public and private encryption key, receive encrypted data, and decrypt encrypted data to authenticate a user requesting processing of an event and/or authorize the processing of the event.

Event processing computing platform 120 may be configured to host and/or execute one or more modules including instructions for providing various event processing functions. For instance, event processing computing platform 120 may receive a request to process an event, may encrypt event processing device identification information, may encrypt user identification information, such as a personal identification number (PIN), and process the requested event or deny the requested event based on determinations made by the user authentication and event authorization computing platform 110.

One or more aspects described herein may be performed by one or more applications downloaded or otherwise provided to a computing device (such as first local user computing device 130, second local user computing device 135, first remote user computing device 150, second remote user computing device 155, or the like) and executing thereon. In some examples, the one or more applications may execute in background of the device.

Although various devices in the user authentication and event processing system are shown and described as separate device, one or more of user authentication and event authorization computing platform 110, event processing computing platform 120, first local user computing device 130, second local user computing device 130, first remote user computing device 150, and/or second remote user computing device 155, may be part of a single computing device without departing from the invention.

Local user computing device 130, 135 and remote user computing device 150, 155 may be configured to communicate with and/or connect to one or more computing devices or systems shown in FIG. 1A. For instance, local user computing device 130, 135 may communicate with one or more computing systems or devices via network 140, while remote user computing device 150, 155 may communicate with one or more computing systems or devices via network 145. The local and remote user computing devices may be used to capture event processing device information, such as an event processing device identifier, receive personal identifying information, such as a PIN, of a user, and the like, as will be discussed more fully herein.

In one or more arrangements, local user computing device 130, local user computing device 135, remote user computing device 150, and/or remote user computing device 155 may be any type of computing device or combination of devices capable of performing the particular functions described herein. For example, local user computing device 130, local user computing device 135, remote user computing device 150, and/or remote user computing device 155 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of user authentication and event authorization computing platform 110, event processing computing platform 120, local user computing device 130, local user computing device 135, remote user computing device 150, and/or remote user computing device 155 may, in some instances, be or include special-purpose computing devices configured to perform specific functions.

Computing environment 100 also may include one or more computing platforms. For example, and as noted above, computing environment 100 may include user authentication and event authorization computer platform 110, event processing computing platform 120, and the like. As illustrated in greater detail below, user authentication and event authorization computer platform 110 and/or event processing computing platform 120 may include one or more computing devices configured to perform one or more of the functions described herein. For example, user authentication and event authorization computer platform 110 and/or event processing computing platform 120 may have or include one or more computers (e.g., laptop computers, desktop computers, tablet computers, servers, server blades, or the like).

As mentioned above, computing environment 100 also may include one or more networks, which may interconnect one or more of user authentication and event authorization computer platform 110, event processing computing platform 120, local user computing device 130, local user computing device 135, remote user computing device 150, and/or remote user computing device 155. For example, computing environment 100 may include private network 140 and public network 145. Private network 140 and/or public network 145 may include one or more sub-networks (e.g., Local Area Networks (LANs), Wide Area Networks (WANs), or the like). Private network 140 may be associated with a particular organization (e.g., a corporation, financial institution, educational institution, governmental institution, or the like) and may interconnect one or more computing devices associated with the organization. For example, user authentication and event authorization computer platform 110, event processing computing platform 120, local user computing device 130, and/or local user computing device 135, may be associated with an organization (e.g., a financial institution), and private network 140 may be associated with and/or operated by the organization, and may include one or more networks (e.g., LANs, WANs, virtual private networks (VPNs), or the like) that interconnect user authentication and event authorization computer platform 110, event processing computing platform 120, local user computing device 130, and/or local user computing device 135, and one or more other computing devices and/or computer systems that are used by, operated by, and/or otherwise associated with the organization. Public network 145 may connect private network 140 and/or one or more computing devices connected thereto (e.g., user authentication and event authorization computer platform 110, event processing computing platform 120, local user computing device 130, local user computing device 135) with one or more networks and/or computing devices that are not associated with the organization. For example, remote user computing device 130 and remote user computing device 135 might not be associated with an organization that operates private network 140 (e.g., because remote user computing device 130 and remote user computing device 135 may be owned, operated, and/or serviced by one or more entities different from the organization that operates private network 140, such as one or more customers of the organization, public or government entities, and/or vendors of the organization, rather than being owned and/or operated by the organization itself or an employee or affiliate of the organization), and public network 145 may include one or more networks (e.g., the internet) that connect remote user computing device 130 and remote user computing device 135 to private network 140 and/or one or more computing devices connected thereto (e.g., user authentication and event authorization computer platform 110, event processing computing platform 120, local user computing device 130, local user computing device 135).

Referring to FIG. 1B, event processing computing platform 120 may include one or more processors 121, memory 122, and communication interface 123. A data bus may interconnect processor(s) 121, memory 122, and communication interface 123. Communication interface 123 may be a network interface configured to support communication between event processing computing platform 120 and one or more networks (e.g., private network 140, public network 145, or the like). Memory 122 may include one or more program modules having instructions that when executed by processor(s) 121 cause event processing computing platform 120 to perform one or more functions described herein and/or one or more databases that may store and/or otherwise maintain information which may be used by such program modules and/or processor(s) 121. In some instances, the one or more program modules and/or databases may be stored by and/or maintained in different memory units of event processing computing platform 120 and/or by different computing devices that may form and/or otherwise make up event processing computing platform 120.

For example, memory 122 may have, store, and/or include an event processing device reader module 122a. The event processing device reader module 122a may store instructions and/or data that may cause or enable the event processing computing platform 120 to read or extract data from one or more event processing devices. In some examples, an event processing device may include a credit card, debit card, or the like. In some arrangements, the data may be read or extracted from the event processing device by reading data encoded in a magnetic strip on the device, by extracted data from a chip embedded in the device, or the like. The event processing device reader module 122a may receive data by a user swiping the event processing device to access data stored on the magnetic strip, by the user inserting the event processing device into a chip reader device to read or extract data stored on the chip, or may obtain the data wirelessly from a device connected to or in communication with a user computing device (such as local user computing device 130, 135, remote user computing device 150, 155, or the like). In some examples, data may be received wirelessly via a mobile payment application executing on the computing device.

The event processing device reader module 122a may read or extract, for example, an event processing device identifier, such as a number associated with the event processing device. This information may then be used to authenticate a user and/or process an event, as will be discussed more fully herein.

Memory 122 may further have, store and/or include a first process encryption module 122b. The first process encryption module 122b may store instructions and/or data that may cause or enable the event processing computing platform 120 to encrypt the data read or extracted from the event processing device using a first encryption process. For instance, the event processing device identifier may be encrypted using a first encryption process. In some examples, the first encryption process may be a key management cryptography scheme, such as derived unique key per transaction (DUKPT). In other examples, various other encryption processes may be used.

Memory 122 may further have, store and/or include a user identifier reader module 122c. The user identifier reader module 122c may store instructions and/or data that may cause or enable the event processing computing platform 120 to receive personal identifying information from a user, such as a user requesting processing of an event. In some examples, the personal identifying information may include user identifier, such as a personal identification number (PIN). In some arrangements, the PIN may be received via the computing device, such as local user computing device 130, 135, remote user computing device 150, 155, or the like. In some examples, the computing device may be tablet computing device used to request processing of an event. In these examples, the tablet computing device, or a supplemental device connected thereto or in communication therewith, may read or extract the data from the event processing device, and the user identifier may be received, for example, via a touch screen display of the tablet computing device. Accordingly, both the event processing device identifier and the user identifier may be received by the same device for processing.

Memory 122 may further have, store, and/or include a second process encryption module 122d. The second process encryption module 122d may store instructions and/or data that may cause or enable the event processing computing platform 120 to encrypt the received user identifier using a second encryption process. In some examples, the second encryption process may be different from the first encryption process. In other examples, the second encryption process may be the same type of encryption process as the first encryption process.

In some examples, in which the first encryption process includes a DUKPT process, the second process encryption module 122d may encrypt the user identifier, as well as the encrypted event processing device identifier and associated key serial number (KSN). In some examples, the second encryption process may include receiving a generated public key of a pair of keys (e.g., public and private) and encrypting the user identifier, encrypted event processing device identifier and KSN using the public key.

Memory 122 may further have, store and/or include an application lock control module 122e. The application lock control module 122e may store instructions and/or data that may cause or enable the event processing computing platform 120 to prevent other applications executing on a computing device (e.g., the computing device being used to request processing of the event, the computing device receiving the event processing device identifier and user identifier, or the like). For instance, upon receiving a request to process an event (e.g., via user input, initiation by reading the even processing device, or the like), the application lock control module 122e may lock some or all of the other applications executing on the computing device to prevent the other applications from access data associated with the event processing device, user, or the like. In some examples, locking the other applications may include temporarily disabling the other applications, automatically closing the other applications, or the like.

Memory 122 may further have, store and/or include an event processing module 122f. The event processing module 122f may store instructions and/or data that may cause or enable the event processing computing platform 120 to process one or more requested events. In some examples, processing an event may include processing a transaction to make a purchase using the event processing device. In some arrangements, processing the event (or denying a request to process an event) may be performed in response to one or more user authentication and/or event authorization steps performed, for example, by the user authentication and event authorization computing platform 110, as will be discussed more fully herein.

Memory 122 may further have, store and/or include a notification generation module 122g. Notification generation module 122g may store instructions and/or data that may cause or enable the event processing computing platform 120 to generate one or more notifications and cause the one or more notifications to be displayed on a computing device, such as local computing device 130, 135, remote computing device 150, 155, or the like. For instance, the notification generation module 122g may generate one or more notifications indicating that a requested event has been authorized for processing or denied, may include one or more options for a user to select, and the like. The notification may be transmitted to and displayed via display of the computing device requesting the event, receiving the event processing device data, user identifier, and the like.

Referring to FIG. 1C, user authentication and event authorization computing platform 110 may include one or more processors 111, memory 112, and communication interface 113. A data bus may interconnect processor(s) 111, memory 112, and communication interface 113. Communication interface 113 may be a network interface configured to support communication between user authentication and event authorization computing platform 110 and one or more networks (e.g., private network 140, public network 145, or the like). Memory 112 may include one or more program modules having instructions that when executed by processor(s) 111 cause user authentication and event authorization computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of user authentication and event authorization computing platform 110 and/or by different computing devices that may form and/or otherwise make up user authentication and event authorization computing platform 110.

For example, memory 112 may have, store, and/or include a key generation module 112a. Key generation module 112a may store instructions and/or data that may cause or enable the user authentication and event authorization computing platform 110 to generate one or more keys or pairs of keys for use in one or more of the encryption processes and/or associated decryption processes. For instance, the key generation module 112a may generate a base derivation key (BDK) which may be used to generate an initial pin encryption key (IPEK). Further, the key generation module 112a may generate one or more pairs of keys (e.g., a public key and an associated private key) for use in encrypting data received with requests for processing events. For example, key generation module 112a may generate a public key and a private key pair in response to a request to process an event. The public key may be transmitted to the computing device requesting processing of the event (e.g., computing device 130, 135, computing device 150, 155, or the like) and may be used by the device to encrypt data. The private key may be used to later decrypt encrypted data, as will be discussed more fully below.

Memory 112 may further have, store and/or include a second process decryption module 112b. The second process decryption module 112b may store instructions and/or data that may cause or enable user authentication and event authorization computing platform 110 to decrypt data received by the user authentication and event authorization computing platform 110. For instance, the private key may be used to decrypt the data encrypted using the second encryption process by the second process decryption module 112b.

Memory 112 may further have, store and/or include a first process decryption module 112c. The first process decryption module 112c may store instructions and/or data that may cause or enable the user authentication and event authorization computing platform 110 to decrypt data encrypted using the first encryption process. For instance, the event processing device identifier may be decrypted using the BDK and KSN by the first process decryption module 112c.

Memory 112 may further have, store and/or include an authentication/authorization module 112d. The authentication/authorization module 112d may store instructions and/or data that may cause or enable the user authentication and event authorization computing platform 110 to authenticate a user based on decrypted information and authorize processing of an event based on an outcome of the user authentication. For instance, decrypted information, such as an event processing device identifier, user identifier, and the like, may be compared to pre-stored information (e.g., information provided by a user, for instance, when registering, upon receiving the event processing device, or the like). In some examples, the user identifier may be compared to a pre-stored user identifier associated with the event processing device to determine whether the user is authenticated and/or whether to authorize processing of the event. For instance, the decrypted event processing device identifier may be used as an input to query a database 112e containing event processing device information, associated user information, and the like. Based on the query, a pre-stored user identifier, such as a PIN, may be identified and compared to the PIN received and decrypted during the event processing request. If the PINs match, the user may be authenticated and processing the event may be authorized. If the PINs do not match, the user might not be authenticated and the request to process the event may be denied. The outcome of the user authentication and event authorization processes performed by the authentication/authorization module 112d may be transmitted to the event processing computing platform 120 (e.g., to the event processing module 122f) to enable event processing functions or disable event processing. An associated notification may then be generated by the notification generation module 122g and transmitted for display.

In some examples, the authentication/authorization module 112d may perform additional encryption and/or decryption of one or more pieces of data to perform one or more user authentication and/or event authorization processes. For instance, in some examples, a PIN block format 0 may be created and may be encrypted using one or more encryption processes, such as by one or more systems unique or used in event processing. This information may then be decrypted to determine whether event processing should occur.

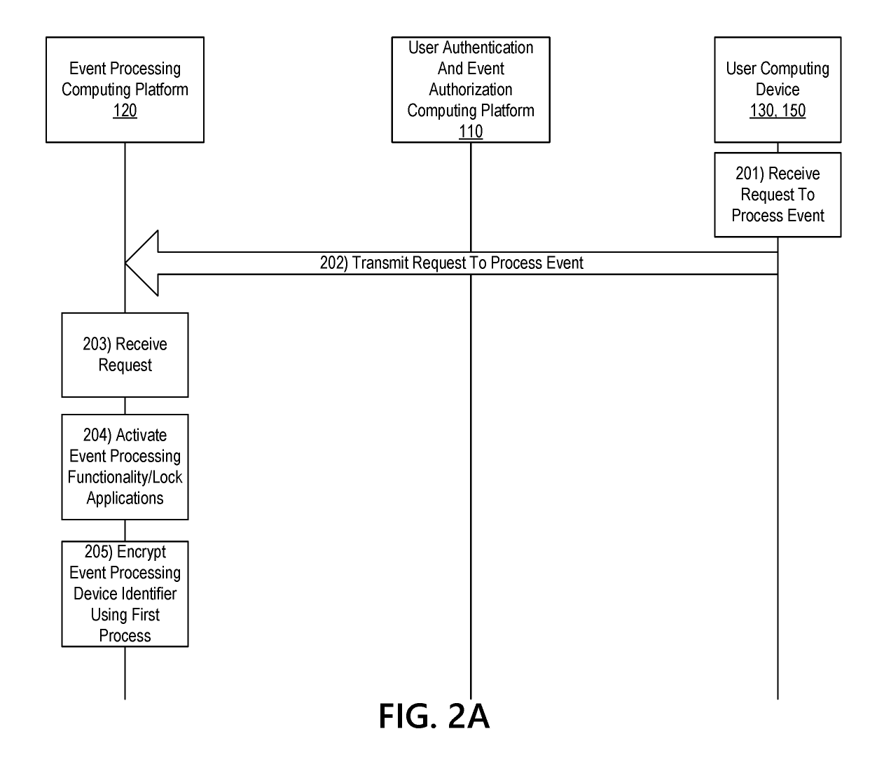

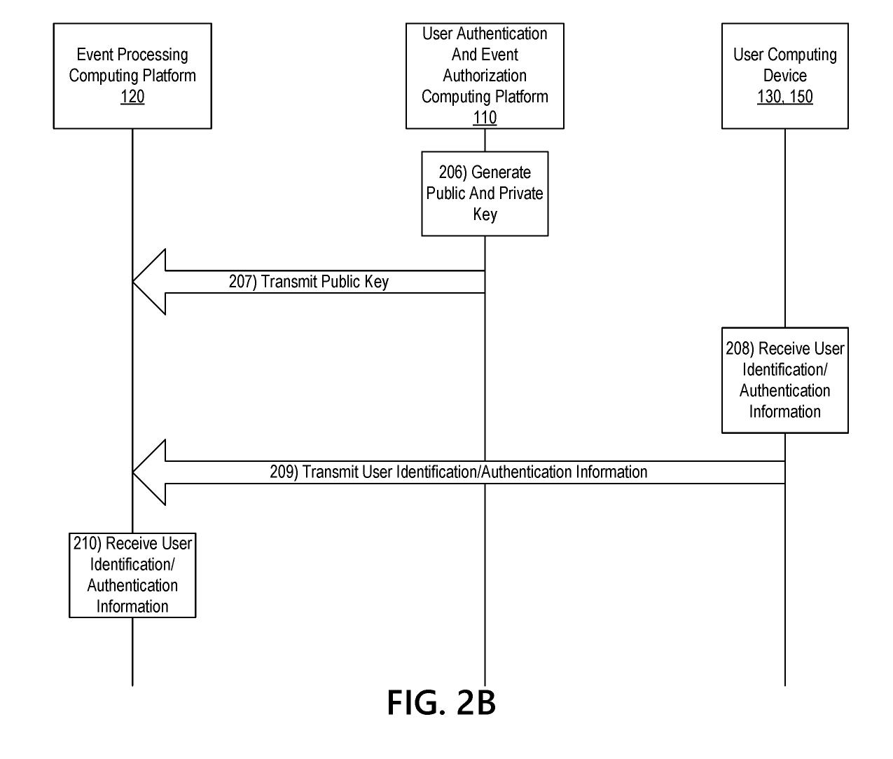

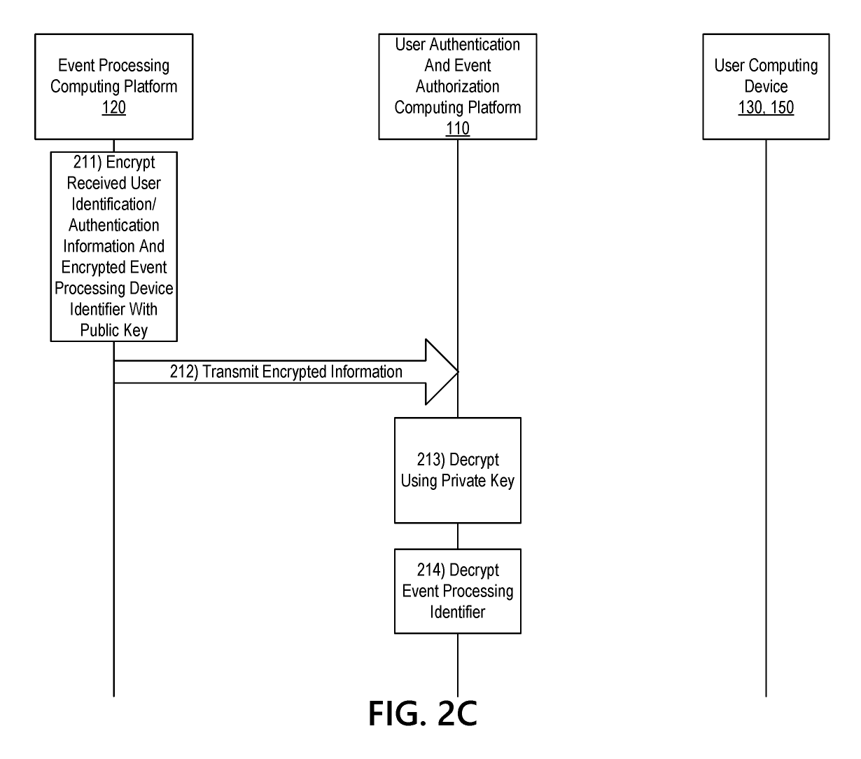

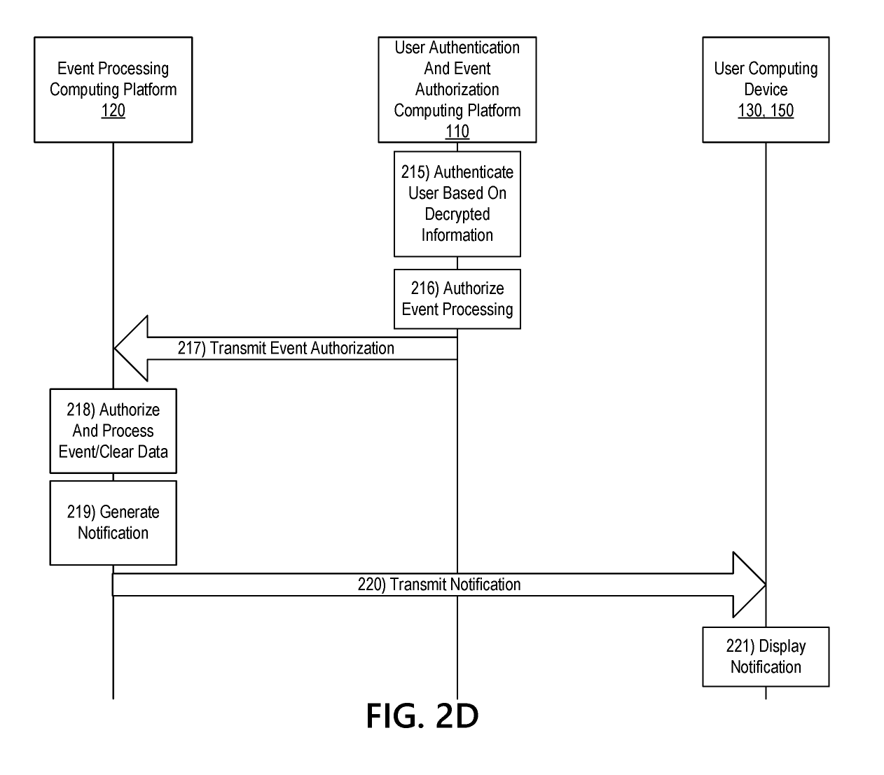

FIGS. 2A-2D depict an illustrative event sequence for implementing and using user authentication and event authorization control functions in accordance with one or more aspects described herein. The events shown in the illustrative event sequence are merely one example sequence and additional events may be added, or events may be omitted, without departing from the invention.

Referring to FIG. 2A, at step 201, a request to process an event may be received. In some examples, an event may include a purchase or other transaction. The request for processing the event may be received via user input to a computing device, such as one or more of local user computing device 130, local user computing device 135, remote user computing device 150, and/or remote user computing device 155 (shown in FIGS. 2A-2D as “User Computing Device 130, 150”). In some arrangements, the request to process an event may be received or initiated by a user submitting information associated with an event processing device, such as a debit card, credit card, mobile payment application executing on a computing device, or the like, to the user computing device 130, 150. For instance, a user may swipe an event processing device to permit or enable the user computing device 130, 150 to read data from a magnetic strip on the event processing device, a user may insert the event payment device to enable the user computing device 130, 150 to read data from a chip embedded in the event processing device, and/or information may be transmitted wirelessly (e.g., from a mobile payment application executing on a computing device, or the like) to the user computing device 130, 150 to initiate or request processing of the event.

In some examples, receiving the request to process the event may include reading or extracting information from the event processing device. For instance, an event processing device identifier may be read from the device (e.g., from the magnetic strip, from the chip, or the like) or extracted from the event processing device.

In step 202, the request to process the event may be transmitted from the user computer device 130, 150 to the event processing computing platform 120. In some examples, the transmitted request may include the information read or extracted from the event processing device. In step 203, the request to process the event, and associated data, may be received by the event processing computing platform 120.

In step 204, event processing functionality may be activated or initiated based on receipt of the request to process the event. In some examples, activating or initiating event processing functionality may cause other applications executing on the computing device 130, 150 to lock or be disabled to ensure that data from event processing device, user identification information, and the like, are not accessible to other applications. In step 205, the extracted event processing device identifier may be encrypted using a first encryption process. In some examples, encrypting the event processing device identifier may result in generation of first encrypted data.

With reference to FIG. 2B, in step 206, a pair of public and private keys may be generated for use in encrypting additional data. In step 207, the public key may be transmitted to the event processing computing platform 120. In some examples, the public key may be stored by the event processing computing platform 120.

In step 208, user identification/authentication information may be received. For instance, user identification or authentication information, such as a unique user identifier, personal identification number (PIN), or the like may be received by the user computing device 130, 150. In step 209, the received user identification/authentication information may be transmitted to the event processing computing platform 120. In step 210, the user identification/authentication information may be received by the event processing computing platform 120.

In some examples, the event processing device identifier and/or the user identification/authentication information may be received via a channel that is not considered secure. For instance, the event processing device identifier and/or user identification/authentication information may be received via a computing device, such as a mobile computing device, which might not be considered a secure channel. Although many aspects described herein are described in relation to receiving event processing device information, user identifying information, and the like, via a computing device, such as a mobile computing device, various other channels, such as a telephone system, smartphone, desktop or laptop computer, or the like, may be used without departing from the invention.

With reference to FIG. 2C, in step 211, the received user identification/authentication information may be encrypted using a second encryption process. For instance, the user identification/authentication information may be encrypted using the public key. In some examples, the user identification/authentication information, as well as the first encrypted data (e.g., the encrypted event processing device identifier) may be encrypted using the public key. In some arrangements, the user identification/authentication information, first encrypted data, and KSN associated with encryption of the event processing device identifier may be encrypted by the second encryption process. The second encryption process may result in second encrypted data (e.g., encrypted forms of the user identification/authentication information, KSN, encrypted event processing device identifier, and the like).

In step 212, the second encrypted data may be transmitted to the user authentication and event authorization computing platform 110. In step 213, the second encrypted information may be decrypted (e.g., via a second decryption process) using the public key associated with the private key (e.g., generated in step 206). In step 214, the first encrypted data (e.g., encrypted event processing device identifier, and the like) may be decrypted (e.g., using a first decryption process). In some examples, the first encrypted data may be decrypted using the BDK and KSN associated with the first encryption process.

With reference to FIG. 2D, in step 215, the user requesting processing of the event may be authenticated based on the decrypted information. For instance, the decrypted PIN may be compared to a pre-stored PIN associated with the event processing device identifier. If the PIN matches the pre-stored PIN, the user may be authenticated and processing of the event may be authorized in step 216.

In step 217, the authorization to process the event may be transmitted from the user authentication and event authorization computer platform 110 to the event processing computing platform 120. In step 218, the event may be processed (e.g., the purchase or transaction may be completed). In some examples, processing the event may further include clearing any data associated with the event. For instance, event processing device identifier, user identifier, and the like, may be deleted from the user computing device 130, 150 so that the information cannot be accessed at a later time or by another application executing on the device.

In step 219, a notification that the event was authorized and/or processed may be generated. In step 220, the generated notification may be transmitted to the user computing device 130, 150 for display. In step 221, the event processing computing platform 120 may transmit a signal, command or instruction to cause the notification to be displayed on the user computing device 130, 150.

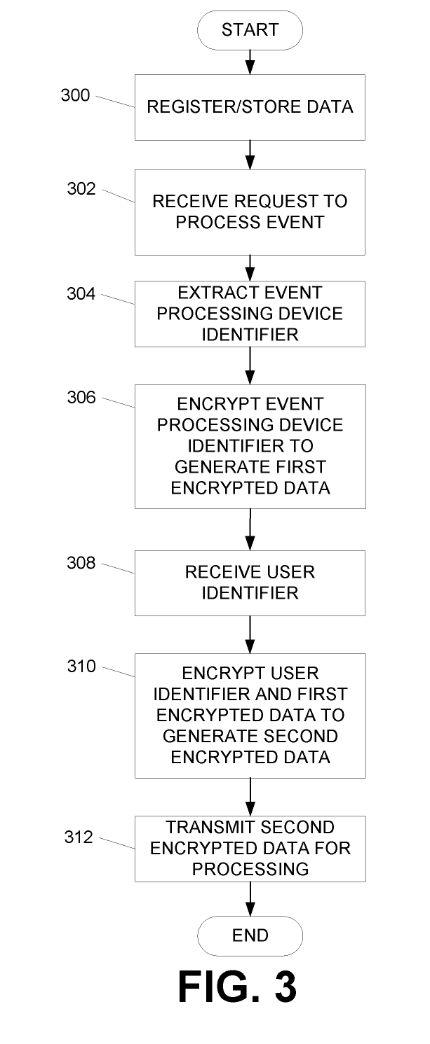

FIG. 3 is a flow chart illustrating one example method of receiving and encrypting data for processing an event in accordance with one or more aspects described herein. The example shown in FIG. 3 is merely one example and the steps and processes shown may be performed in a different order, more steps may be added, or one or more steps may be omitted, without departing from the invention.

In step 300, registration information and/or other data may be stored by one or more computing platforms. For instance, a user may register or activate an event processing device upon receiving the device, first use, or the like. In some examples, registering or activating the event processing device may include pre-storing a PIN associated with the user. In some arrangements, step 300 may be performed once and information may be stored such that the remaining steps shown in FIG. 3 may be performed multiple times without requiring repeating step 300.

In step 302, a request to process an event may be received. As discussed above, the request may be received via user input, via interaction with an event processing device, or the like. In step 304, an event processing device identifier may be extracted from data associated with the requested event. For instance, a user may swipe an event processing device, may insert an event processing device, or the like, to interact with a computing device, such as computing devices 130, 135, 150, 155. Upon interaction with the event processing device, the computing device 130, 135, 150, 155 may extract data from the device, such as an identifier associated with the event processing device.

In step 306, the extracted event processing device identifier may be encrypted using a first encryption process to generate first encrypted data.

In step 308, information identifying a user requesting the processing of the event may be received. In some examples, the information identifying the user may include a PIN or other identifier received via the computing device 130, 135, 150, 155. In step 310, the received information identifying the user may be encrypted with the first encrypted data (and associated data such as a KSN) using a second encryption process to generate second encrypted data. In some examples, the second encryption process may be a same type of encryption process as the first encryption process. In other examples, the second encryption process may be a different encryption process than the first encryption process.

In step 312, the second encrypted data may be transmitted for further processing to authenticate the user and/or authorize processing of the requested event.

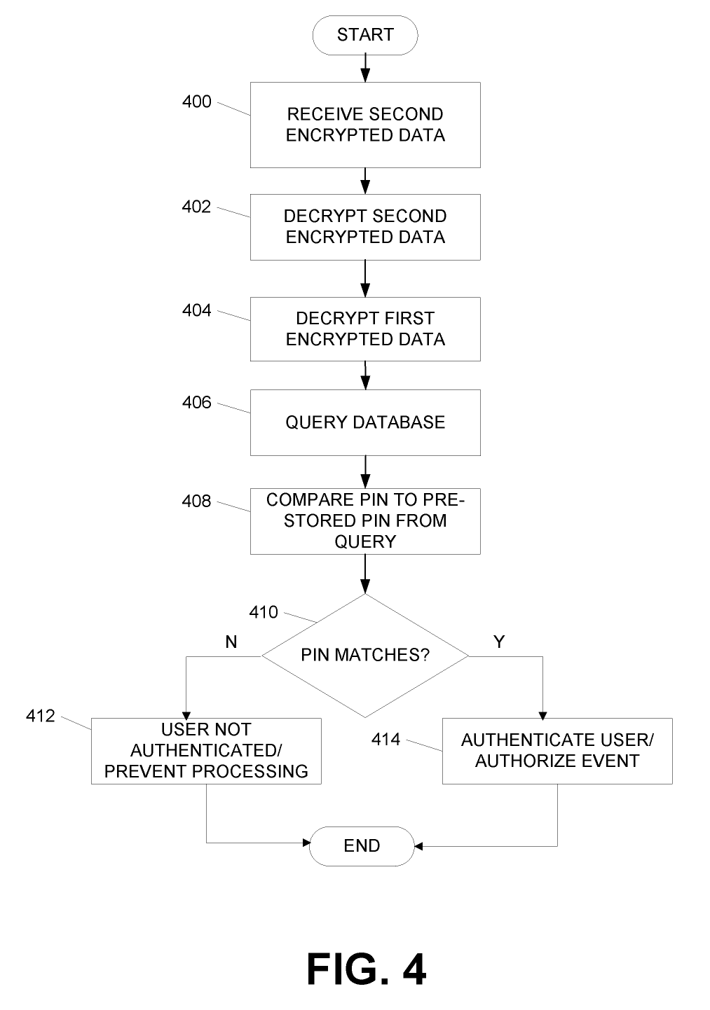

FIG. 4 is a flow chart illustrating one example method of processing encrypted data to authenticate a user and/or authorize processing an event in accordance with one or more aspects described herein. The example shown in FIG. 4 is merely one example and the steps and processes shown may be performed in a different order, more steps may be added, or one or more steps may be omitted, without departing from the invention.

In step 400, the second encrypted data may be received. In step 402, the second encrypted data may be decrypted using a second decryption process. Decrypting the second encrypted data may yield the first encrypted data, received PIN, and associated items.

In step 404, the first encrypted data may be decrypted using a first decryption process. Decrypting the first encrypted data may yield the event processing device identifier. In step 406, the event processing device identifier may be used an input to query a database to identify a pre-stored PIN associated with the event processing identifier. In step 408, the pre-stored PIN may be compared to the received, decrypted PIN.

In step 410, a determination may be made as to whether the pre-stored PIN matches the decrypted PIN. If so, the user may be authenticated and an instruction to process the event may be transmitted in step 414. If the pre-stored PIN does not match the decrypted PIN, the user might not be authenticated and a signal or instruction preventing processing of the requested event may be transmitted.

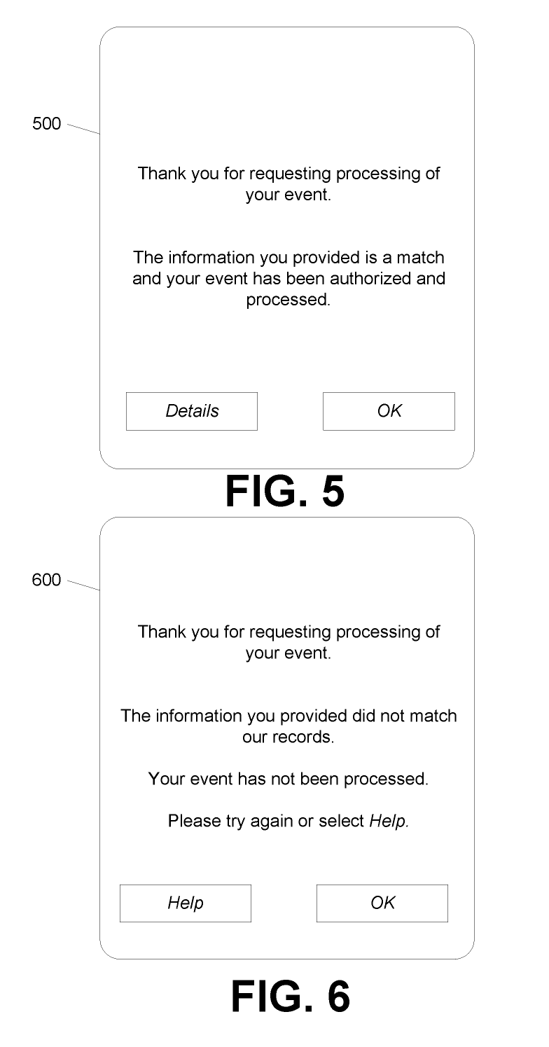

FIG. 5 illustrates one example user interface including a notification that may be generated. The interface 500 includes an indication that the information provided matches pre-stored information and that the event has been processed. In some examples, one or more options for additional details about the event may be provided for selection.

FIG. 6 illustrates one example user interface including a notification that may be generated. The interface 600 includes an indication that the information provided does not match pre-stored information. Accordingly, the event has not been processed. The user interface provides options for the user to request additional information or help from a system administrator, or the like.

As discussed herein, the arrangements described provide for identification of a user and authentication and authorization in one step. As discussed herein, the arrangements described including joining user identification information to other data, such as an event processing device identifier, to provide the user identification/authentication and/or authorization of the event in one step.

The arrangements described herein provide for ensuring information security using encryption in processing events. Although encryption processes such as DUKPT are described above, various other encryption processes may be used without departing from the invention. Further, the encryption processes used, and the various processes described herein, may comply with the standards of one or more regulatory bodies regulating processing of events and/or use of data associated therewith.

Further, in addition to encryption aspects described herein, various other aspects aid in ensuring information security when processing events. For instance, in some examples, upon initiating a request to process an event, the computing device receiving the event processing device identifier, user identifying information, and the like, may lock or disable other applications executing on the computing device to ensure that other applications are prevented from accessing the data associated with processing the event.

Additionally or alternatively, in some examples, after processing the requested event, data associated with the event may be deleted or removed from the computing device and/or any associated systems. For instance, an event processing device identifier, user identifying information, or the like, may be deleted to prevent unauthorized access to the information.

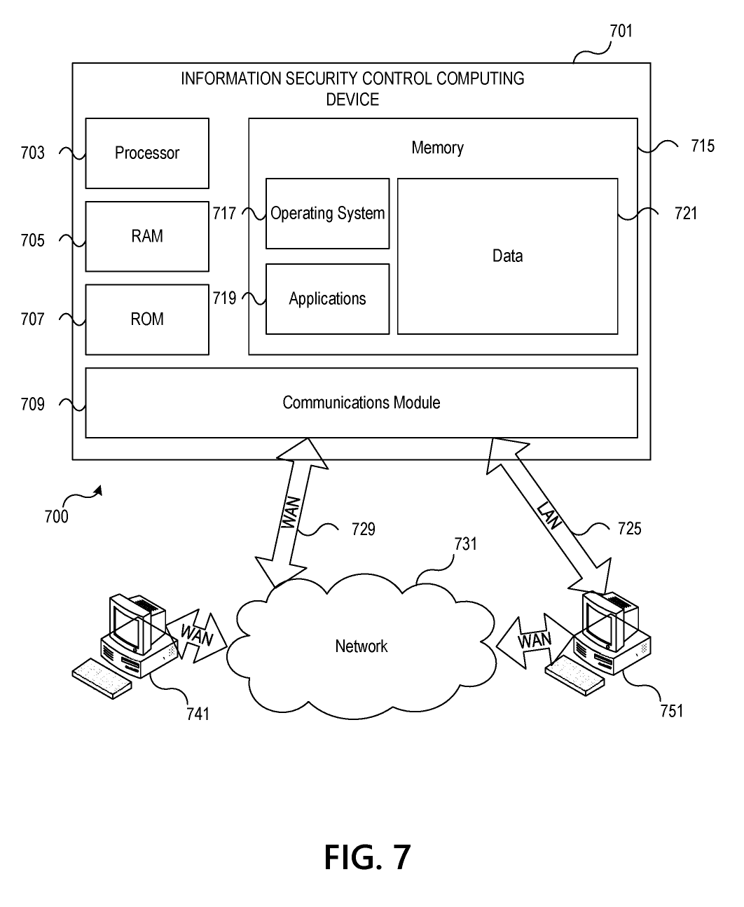

FIG. 7 depicts an illustrative operating environment in which various aspects of the present disclosure may be implemented in accordance with one or more example embodiments. Referring to FIG. 7, computing system environment 700 may be used according to one or more illustrative embodiments. Computing system environment 700 is only one example of a suitable computing environment and is not intended to suggest any limitation as to the scope of use or functionality contained in the disclosure. Computing system environment 700 should not be interpreted as having any dependency or requirement relating to any one or combination of components shown in illustrative computing system environment 700.

Computing system environment 700 may include information security control computing device 701 having processor 703 for controlling overall operation of information security control computing device 701 and its associated components, including Random Access Memory (RAM) 705, Read-Only Memory (ROM) 707, communications module 709, and memory 715. Information security control computing device 701 may include a variety of computer readable media. Computer readable media may be any available media that may be accessed by information security control computing device 701, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 701.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on information security control computing device 701. Such a processor may execute computer-executable instructions stored on a computer-readable medium.

Software may be stored within memory 715 and/or storage to provide instructions to processor 703 for enabling information security control computing device 701 to perform various functions. For example, memory 715 may store software used by information security control computing device 701, such as operating system 717, application programs 719, and associated database 721. Also, some or all of the computer executable instructions for information security control computing device 701 may be embodied in hardware or firmware. Although not shown, RAM 705 may include one or more applications representing the application data stored in RAM 705 while information security control computing device 701 is on and corresponding software applications (e.g., software tasks) are running on information security control computing device 701.

Communications module 709 may include a microphone, keypad, touch screen, and/or stylus through which a user of information security control computing device 701 may provide input, and may also include one or more of a speaker for providing audio output and a video display device for providing textual, audiovisual and/or graphical output. Computing system environment 700 may also include optical scanners (not shown). Exemplary usages include scanning and converting paper documents, e.g., correspondence, receipts, and the like, to digital files.

Information security control computing device 701 may operate in a networked environment supporting connections to one or more remote computing devices, such as computing devices 741 and 751. Computing devices 741 and 751 may be personal computing devices or servers that include any or all of the elements described above relative to information security control computing device 701.

The network connections depicted in FIG. 7 may include Local Area Network (LAN) 725 and Wide Area Network (WAN) 729, as well as other networks. When used in a LAN networking environment, information security control computing device 701 may be connected to LAN 725 through a network interface or adapter in communications module 709. When used in a WAN networking environment, information security control computing device 701 may include a modem in communications module 709 or other means for establishing communications over WAN 729, such as network 731 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

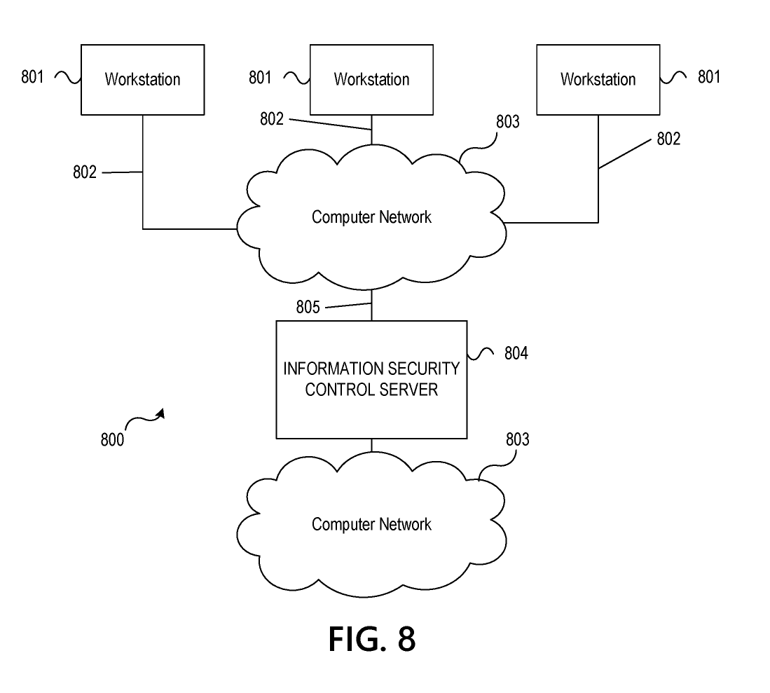

FIG. 8 depicts an illustrative block diagram of workstations and servers that may be used to implement the processes and functions of certain aspects of the present disclosure in accordance with one or more example embodiments. Referring to FIG. 8, illustrative system 800 may be used for implementing example embodiments according to the present disclosure. As illustrated, system 800 may include one or more workstation computers 801. Workstation 801 may be, for example, a desktop computer, a smartphone, a wireless device, a tablet computer, a laptop computer, and the like, configured to perform various processes described herein. Workstations 801 may be local or remote, and may be connected by one of communications links 802 to computer network 803 that is linked via communications link 805 to information security control server 704. In system 700, information security control server 704 may be a server, processor, computer, or data processing device, or combination of the same, configured to perform the functions and/or processes described herein. Server 704 may be used to process received requests, implement one or more information security controls, encrypt data, decrypt data, and the like.

Computer network 703 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 702 and 705 may be communications links suitable for communicating between workstations 701 and information security control server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive a request to process an event;
receive, via a mobile computing device, an event processing device identifier;
encrypt the received event processing device identifier using a first encryption process resulting in first encrypted data;
receive, via the mobile computing device, a user identifier from a user requesting to process the event;
encrypt the first encrypted data and the user identifier using a second encryption process resulting in second encrypted data;
decrypt the second encrypted data using a second decryption process resulting in a decrypted user identifier;
decrypt the first encrypted data using a first decryption process resulting in a decrypted event processing device identifier;
determine, based on the decrypted user identifier and the decrypted event processing device identifier, that the user requesting processing of the event is authenticated; and
authorize processing of the event based on the determining.

2. The computing platform of claim 1, further including instructions that, when executed, cause the computing platform to:
generate a public key and a private key; and
transmit the generated public key to the mobile computing device.

3. The computing platform of claim 2, wherein the second encryption process is performed using the generated public key.

4. The computing platform of claim 3, wherein the second decryption process is performed using the generated private key.

5. The computing platform of claim 1, wherein the user identifier is a personal identification number (PIN).

6. The computing platform of claim 1, wherein the first encryption process is a derived unique key per transaction process.

7. The computing platform of claim 1, wherein encrypting the first encrypted data and the user identifier using a second encryption process resulting in second encrypted data further includes encrypting a key serial number associated with the first encryption process.

8. The computing platform of claim 1, wherein the event processing device identifier is extracted from one of: a magnetic strip on an event processing device and a chip embedded in the event processing device.

9. A method, comprising:
at a computing platform comprising at least one processor, memory, and a communication interface:
receiving a request to process an event;
receiving, via a mobile computing device, an event processing device identifier;
encrypting the received event processing device identifier using a first encryption process resulting in first encrypted data;
receiving, via the mobile computing device, a user identifier from a user requesting to process the event;
encrypting the first encrypted data and the user identifier using a second encryption process resulting in second encrypted data;
decrypting the second encrypted data using a second decryption process resulting in a decrypted user identifier;
decrypting the first encrypted data using a first decryption process resulting in a decrypted event processing device identifier;
determining, based on the decrypted user identifier and the decrypted event processing device identifier, that the user requesting processing of the event is authenticated; and
authorizing processing of the event based on the determining.

10. The method of claim 9, further including:
generating a public key and a private key; and
transmitting the generated public key to the mobile computing device.

11. The method of claim 10, wherein the second encryption process is performed using the generated public key.

12. The method of claim 11, wherein the second decryption process is performed using the generated private key.

13. The method of claim 9, wherein the user identifier is a personal identification number (PIN).

14. The method of claim 9, wherein the first encryption process is a derived unique key per transaction process.

15. The method of claim 9, wherein encrypting the first encrypted data and the user identifier using a second encryption process resulting in second encrypted data further includes encrypting a key serial number associated with the first encryption process.

16. The method of claim 9, wherein the event processing device identifier is extracted from one of: a magnetic strip on an event processing device and a chip embedded in the event processing device.

17. One or more non-transitory computer-readable media storing instructions that, when executed by a computing platform comprising at least one processor, memory, and a communication interface, cause the computing platform to:
receive a request to process an event;
receive, via a mobile computing device, an event processing device identifier;
encrypt the received event processing device identifier using a first encryption process resulting in first encrypted data;
receive, via the mobile computing device, a user identifier from a user requesting to process the event;
encrypt the first encrypted data and the user identifier using a second encryption process resulting in second encrypted data;
decrypt the second encrypted data using a second decryption process resulting in a decrypted user identifier;
decrypt the first encrypted data using a first decryption process resulting in a decrypted event processing device identifier;
determine, based on the decrypted user identifier and the decrypted event processing device identifier, that the user requesting processing of the event is authenticated; and
authorize processing of the event based on the determining.

18. The one or more non-transitory computer-readable media of claim 17, further including instructions that, when executed, cause the computing platform to:
generate a public key and a private key; and
transmit the generated public key to the mobile computing device.

19. The one or more non-transitory computer-readable media of claim 18, wherein the second encryption process is performed using the generated public key.

20. The one or more non-transitory computer-readable media of claim 19, wherein the second decryption process is performed using the generated private key.

21. The one or more non-transitory computer-readable media of claim 17, wherein the user identifier is a personal identification number (PIN).

22. The one or more non-transitory computer-readable media of claim 17, wherein the first encryption process is a derived unique key per transaction process.

23. The one or more non-transitory computer-readable media of claim 17, wherein encrypting the first encrypted data and the user identifier using a second encryption process resulting in second encrypted data further includes encrypting a key serial number associated with the first encryption process.

24. The one or more non-transitory computer-readable media of claim 17, wherein the event processing device identifier is extracted from one of: a magnetic strip on an event processing device and a chip embedded in the event processing device.
